(19) United States
(12) Patent Application Publication
(10) Pub. No.: US 2020/0212809 A1
(43) Pub. Date: Jul. 2, 2020

(54) POWER CONVERSION USING DUAL SWITCH WITH PARALLEL TRANSISTORS HAVING DIFFERENT BLOCKING VOLTAGES

(71) Applicant: TEXAS INSTRUMENTS INCORPORATED, Dallas, TX (US)

(72) Inventors: Shailendra Kumar BARANWAL, Murphy, TX (US); Jeffrey MORRONI, Parker, TX (US)

(21) Appl. No.: 16/233,168

(22) Filed: Dec. 27, 2018

(51) Int. Cl. H02M 3/335

(52) U.S. Cl. CPC H02M 3/33507; H02M 2001/0006

(57) ABSTRACT

A power converter includes a first switch with a first transistor having a first blocking voltage in parallel with a second transistor having a second blocking voltage that is higher than the first blocking voltage. The power converter also includes a second switch. The power converter also includes a controller coupled to the first and second switches and configured to provide switch control signals. The power converter also includes a sequencer coupled to the first and second transistors and configured to generate offset transition signals for the first and second transistors based on a switch control signal provided by the controller.

### BACKGROUND

Power supplies and power converters are used in a variety of electronic systems. Electrical power is generally transmitted over long distances as an alternating current (AC) signal. The AC signal is divided and metered as desired for each business or home location, and is often converted to direct current (DC) for use with individual electronic devices or components. Modern electronic systems often employ devices or components designed to operate using different DC voltages. Accordingly, different DC-DC converters, or a DC-DC converter that supports a wide range of output voltages, are needed for such systems.

One of the problems encountered with DC-DC converters is that the performance and/or functionality of switches (transistors) used to transfer power degrade over time. One cause of switch degradation is referred to as “hot carrier injection.” The main source of the hot carriers is the high energy carrier inside the channel of transistors during switching operations. Sometimes these energetic carriers lead to impact ionization within the substrate and the generated electrons or holes inside the channel or the heated carriers themselves are injected into the gate oxide. During this process, the injected carriers sometimes generate interface or bulk oxide defects and as a result, transistor characteristics (e.g., threshold voltage, transconductance, etc.) degrade over time.

Previous efforts to account for degradation issues due to hot carrier injection involve use of switches with a higher drain to source breakdown voltage (Bvdss) rating. The Bvdss rating of a switch determines its maximum blockage voltage. However, switches with higher Bvdss voltages dissipate more power during switching operations. Efforts to improve power conversion circuits and degradation issues are ongoing.

### SUMMARY

In accordance with at least one example of the disclosure, a power converter comprises a first switch with a first transistor having a first blocking voltage in parallel with a second transistor having a second blocking voltage that is higher than the first blocking voltage. The power converter also comprises a second switch. The power converter also comprises a controller coupled to the first and second switches and configured to provide switch control signals. The power converter also comprises a sequencer coupled to the first and second transistors and configured to generate offset transition signals for the first and second transistors based on a switch control signal provided by the controller.

In accordance with at least one example of the disclosure, a power conversion method comprises outputting, by a controller, a switch control signal. The method also comprises providing, by a sequencer, offset transition signals based on the switch control signal. The method also comprises providing the offset transition signals to parallel transistors including a first parallel transistor having a first blocking voltage and a second parallel transistor having a second blocking voltage that is higher than the first blocking voltage. The method also comprises using one of the offset transition signals to change an on/off state of the first parallel transistor. The method also comprises using another of the offset transition signals to change an on/off state of the second parallel transistor.

### BRIEF DESCRIPTION OF THE DRAWINGS

For a detailed description of various examples, reference will now be made to the accompanying drawings in which:

FIG. 1 shows a block diagram of a system with power conversion in accordance with various examples;

FIG. 2 shows a schematic diagram of a step-down power converter in accordance with various examples;

FIG. 3 shows a timing diagram for a power converter in accordance with various examples;

FIG. 4 shows a schematic diagram of another step-down power converter in accordance with various examples;

FIG. 5 shows a schematic diagram of a step-up power converter in accordance with various examples;

FIG. 6 shows a dual switch arrangement with NMOS transistors in accordance with various examples;

FIG. 7 shows a dual switch arrangement with PMOS transistors in accordance with various examples;

FIGS. 8A-8C show power converter device options in accordance with various examples; and

FIG. 9 shows a flowchart of a power conversion method in accordance with various examples.

### DETAILED DESCRIPTION

The disclosed examples are directed to power converters that employ a dual switch (sometimes referred to herein as a first switch) with parallel transistors having different blocking voltages. More specifically, the dual switch employs a first transistor having a first blocking voltage in parallel with a second transistor having a second blocking voltage, where the second block voltage is higher than the first blocking voltage. By strategically controlling the timing of when the first and second transistors of the dual switch operate, certain benefits are achieved. More specifically, the first transistor has significantly lower resistance compared to the second transistor, which reduces power loss compared to using only the second transistor. Meanwhile, the second transistor provides the advantage of reducing hot carrier injection compared to using only the first transistor. To perform a switching operation, the dual switch uses offset transition signals. In an example off-to-on switching operation, a gate of the second transistor (the parallel transistor with a higher blocking voltage) receives a first offset transition signal, while a gate of the first transistor (the parallel transistor with a lower blocking voltage) receives a second offset transition signal that is delayed relative to the first offset transition signal. Because the second transistor is already on when the first transistor receives the second offset transition signal, the transition of the first transistor from off-to-on is eased. In an example on-to-off switching operation, a gate of the first transistor (the parallel transistor with a lower blocking voltage) receives a first offset transition signal, while a gate of the second transistor (the parallel transistor with a higher blocking voltage) receives a second offset transition signal that is delayed relative to the first offset transition signal. Because the second transistor is on when the first transistor receives the first offset transition signal, the transition of the first transistor from on-to-off is eased.

Employing a dual switch with parallel transistors having different blocking voltages enables the parallel transistor with a larger blocking voltage to handle stressful on-to-off or off-to-on transitions (extending the life of the parallel transistor with a smaller blocking voltage). Meanwhile, the parallel transistor with a smaller blocking voltage improves the efficiency of power conversion operations for the dual switch compared to using only one transistor with a larger blocking voltage.

In some examples, a dual switch with parallel transistors having different blocking voltages is employed in a step-down converter to handle high-side switching. In other examples, a dual switch with parallel transistors having different blocking voltages is employed in a step-up converter to handle low-side switching. In different examples, power converter devices that employ a dual switch with parallel transistors having different blocking voltages include passive components such as input capacitors, output capacitors, input inductors, or output inductors. In other examples, power converter devices that employ a dual switch with parallel transistors having different blocking voltages omit passive components (the passive components are later selected by a designer and added to an electrical system along with the power converter device). In different examples, power converter devices correspond to step-up converter or step-down converters. Also, in some examples, power converter devices include feedback loop components to enable adjustment of power conversion operations based on voltage and/or current analysis of an output signal from the power converter device. With feedback loop components, dynamic power conversion adjustments to supply power to a variable load is possible. In other examples, power converter devices omit feedback loop components. To provide a better understanding, various power conversion options, dual switch options, and power converter device options are described using the figures as follows.

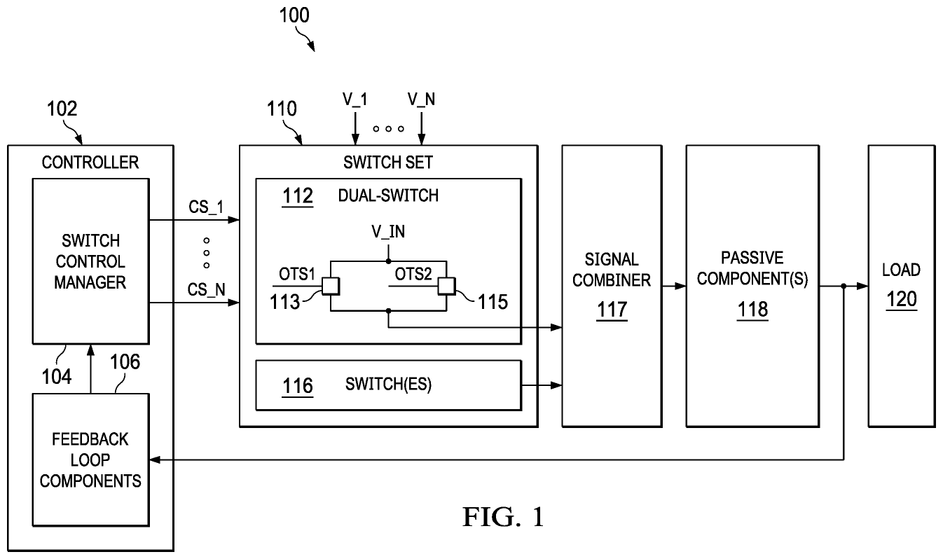

FIG. 1 shows a block diagram of a system 100 with power conversion in accordance with various examples. As shown, the system 100 includes a switch set 110 that includes a dual switch (a first switch) 112 with parallel transistors 113 and 115 having different blocking voltages. More specifically, the parallel transistor 115 has a higher blocking voltage than the parallel transistor 113. In the disclosed examples, the timing of the operation of the parallel transistors 113 and 115 mostly overlaps with some offset between when the parallel transistors 113 and 115 are turned on and off. This offset is controlled by the offset transition signals (OTS1 and OTS2) and has the function of easing on-to-off transitions and/or off-to-on transitions of the parallel transistor 113 by having parallel transistor 115 in an “on” state during transitions of the parallel transistor 113. An example of the timing for the offset transition signals is later given in FIG. 3. In FIG. 1, the offset transition signals are generated within the dual switch 112 in response to a switch control signal (one of CS_1 to CS_N) from the controller 102. In other examples, the offset transition signals are provided by the controller 102 and/or other components of the system 100 for use with directing the parallel transistors 113 and 115 of the dual switch 112.

The switch set 110 also includes at least one additional switch (e.g., a second switch) 114. The switch set 110 is coupled to a controller 102 with a switch control manager 104. In some examples, the controller 102 includes feedback loop components 106. In other examples, the feedback loop components 106 are omitted. In operation, the controller 102 provides switch control signals (CS_1-CS_N) to the switch set 110, where the switch control signals are determined by input from the feedback loop components 106 and/or other control parameters of the switch control manager 104. In different examples, the timing of the switch control signals varies and/or is adjustable. In response to the switch control signals, the dual switch 112 and switch(es) 114 operate to pass respective signals corresponding to at least one supply voltage (V_1 to V_N). In FIG. 1, the dual switch 112 uses a supply voltage V_IN (e.g., one of V_1 to V_N) to provide an output signal. The output signals of the switch set 110 are combined as represented by signal combiner 116, and are provided to passive component(s) 118, which serve to smooth and/or store energy. The signal combiner 116 at least corresponds to conductive materials that merge the signals from the switch set 110. Meanwhile, in some examples, the passive component(s) 118 corresponds to at least one output inductor and/or at least one output capacitor. The output from the passive component(s) 118 is provided to a load 120, which consumes power at a fixed or variable rate.

In FIG. 1, the signal to the load 120 is provided to the feedback loop components 106. In some examples, the feedback loop components 106 perform a voltage analysis of the signal to the load 120. In other examples, the feedback loop components 106 perform a current analysis of the signal to the load 120. In some examples, the feedback loop components 106 analyze the voltage and/or current corresponding to another point in the system 100 besides or instead of the signal to the load 120 (e.g., one of the outputs of the switch set 110, the output of the signal combiner 116). In some examples, the switch control manager 104 includes one or more pulse width modulators to generate the switch control signals (CS_1-CS_N) based on the analysis results of the feedback loop components 106. In other examples, pulse width modulators of the switch control manager 104 have a predetermined or controlled operation that does not rely on the feedback loop components 106.

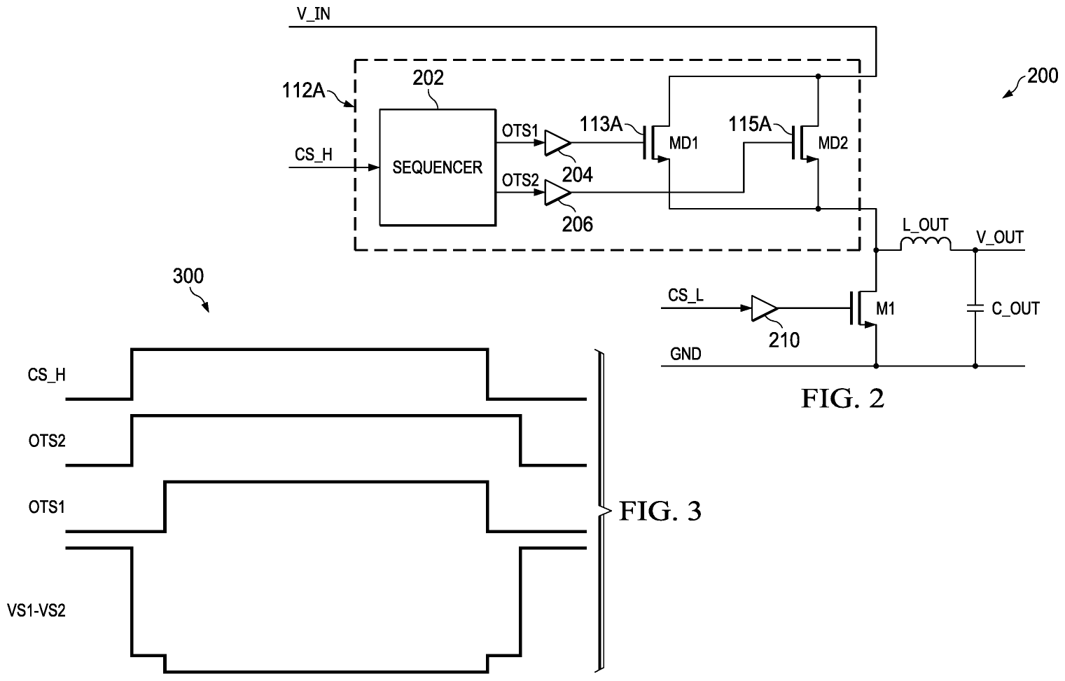

FIG. 2 shows a schematic diagram of a step-down power converter 200 in accordance with various examples. As shown, the step-down power converter 200 comprises the dual switch 112A (an example of the dual switch 112 in FIG. 1) operating as a high-side switch. More specifically, the dual switch 112A comprises a sequencer 202 that generates offset transition signals, OTS1 and OTS2, in response to a high-side switch control signal (CS_H). In some examples, the sequencer 202 comprises a delay component to provide a fixed or adjustable delay between OTS1 and OTS2. Also, the dual switch 112A includes buffers 204 and 206 to drive respective gates of parallel transistors 113A and 115A (labeled MD1 and MD2), where the parallel transistors 113A and 115A are examples of the parallel transistors 113 and 115 in FIG. 1. In response to a sufficient drive signal at its gate, the parallel transistor 113A passes V_IN with some limited voltage drop. Likewise, in response to a sufficient drive signal at its gate, the parallel transistor 115A passes V_IN with some limited voltage drop. As previously described, OTS1 and OTS2 operate to ease on-to-off transitions and/or off-to-on transitions of the parallel transistor 113A by having parallel transistor 115A in an “on” state during transitions of the parallel transistor 113A.

The output of the dual switch 112A is coupled to a low-side switch corresponding to a transistor (M1) coupled to ground (GND). The operation of M1 is directed by a low-side switch control signal (CS_L) through a buffer 210. The output of the dual switch 112A is also coupled to an output-side inductor (L_OUT). As shown, an output-side capacitor (C_OUT) is coupled between L_OUT and GND. In response to a sufficient drive signal at its gate, M1 grounds the signal at L_OUT. Such grounding is not instantaneous and is smoothed by L_OUT and C_OUT. By controlled switching of the dual switch 112A and the low-side switch (M1), the output voltage (V_OUT) across C_OUT for the step-down power converter 200 is controlled. In one example, the step-down power converter 200 converts 12 volts to 5 volts. Without limitation, the converter topology represented in FIG. 2 is referred to as a “buck” converter. In other examples, the dual switch 112A is part of another step-down converter topology.

In the example of FIG. 2, each of the transistors MD1, MD2, and M1 has a gate, a first current terminal, and a second current terminal. As previously discussed, the gates for MD1, MD2, and M1 are coupled to respective buffers 204, 206, 210 and directed by high-side and low-side switch control signals (e.g., switch control signals from a controller such as controller 102 in FIG. 1). More specifically, the high-side switch control signal, CS_H, is used to generate the offset transition signals (OTS1 and OTS2) to direct MD1 and MD2. Meanwhile, the first current terminals of MD1 and MD2 are coupled to a supply voltage node corresponding to V_IN, and the second current terminals of MD1 and MD2 are coupled to the first terminal of M1 and to L_OUT. Finally, the second current terminal of M1 is coupled to a ground node corresponding to GND. In the example of FIG. 2, MD1, MD2, and M1 are represented as NMOS transistors. In other examples, PMOS and/or bipolar transistors are used instead of NMOS transistors.

In different examples, the blocking voltages for MD1 and MD2 for the step-down power converter 200 vary. In one example, where the step-down power converter 200 converts 12 volts to 5 volts, MD1 has a blocking voltage of 12 volts and MD2 has a blocking voltage of 18 volts. In this example, the blocking voltage for MD2 is 50% larger than the blocking voltage for MD1. In other examples, the blocking voltages for MD1 and MD2 are both larger (e.g., 24 volts for MD1 and 36 volts for MD2). In other examples, the proportion of the blocking voltages varies (e.g., the blocking voltage for MD2 is 25% larger, 50% larger, 75% larger, or 100% larger than the blocking voltage for MD1). Also, in different examples, the values for V_IN, V_OUT, L_OUT, and C_OUT of the step-down power converter 200 vary.

FIG. 3 shows a timing diagram 300 for a power converter in accordance with various examples. More specifically, the timing diagram 300 corresponds to the step-down power converter 200 of FIG. 2. As shown in the timing diagram 300, CS_H and OTS2 do low-to-high transition together. In other words, OTS2 directs the parallel transistor with a larger blocking voltage (e.g., parallel transistor 115A) to transition as soon as possible in response to an off-to-on switch control signal, CS_H. Meanwhile, OTS1 is delayed relative to OTS2 in response to an off-to-on switch control signal. After the delay, OTS1 does a low-to-high transition and OTS2 and OTS1 remain in an “on” state together until CS_H does a high-to-low transition (an on-to-off switch control signal). In response to an on-to-off switch control signal, OTS1 directs the parallel transistor with a smaller blocking voltage (e.g., parallel transistor 113A) to do a high-to-low transition as soon as possible. Meanwhile, OTS2 is delayed relative to OTS1 in response to an on-to-off switch control signal. After the delay, OTS2 and OTS1 remain in an “off” state together until a subsequent on-to-off switch control signal is received.

In FIG. 3, the timing diagram 300 also shows a value for VS1-VS2, where VS1 is the voltage at the first current terminal or drains of the parallel transistors 113A and 115A, and where VS2 is the voltage at the second current terminal or sources of the parallel transistors 113A and 115A. As represented in the timing diagram 300, VS1-VS2 is low when the dual switch 112A is on and high (set at V_IN) when the dual switch is off. As shown, VS1-VS2 has a multi-step shape in response to high-to-low and low-to-high transitions due to the offset between OTS2 and OTS1 as described herein.

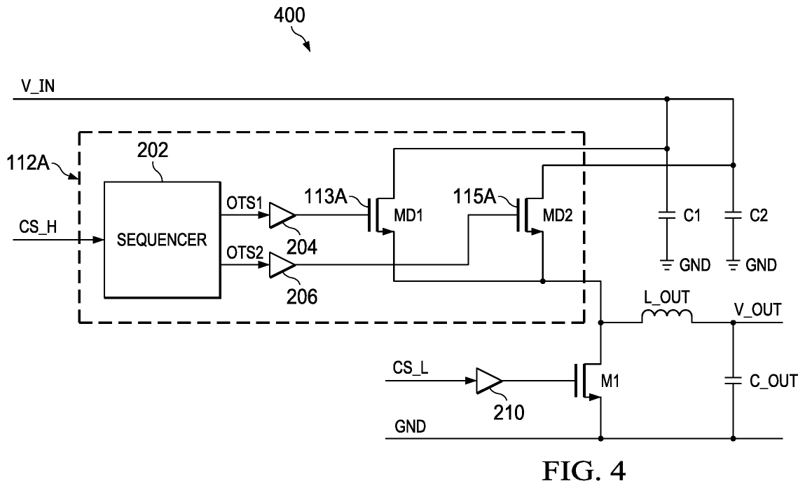

FIG. 4 shows a schematic diagram of another step-down power converter 400 in accordance with various examples. As shown, the step-down power converter 400 includes the same components discussed for the step-down power converter 200 of FIG. 2. Thus, the discussion for the step-down power converter 200 of FIG. 2 applies to the step-down power converter 400 of FIG. 4. In addition, the step-down power converter 400 includes decoupling capacitors (C1 and C2) coupled to the dual switch 112A. More specifically, C1 has a first side coupled to V_IN and the first current terminal of MD1, and a second side coupled to ground. Meanwhile, C2 has a first side coupled to V_IN and the first current terminal of MD2, and a second side coupled to ground. With the decoupling capacitors of the step-down power converter 400, more ringing across MD2 is permissible.

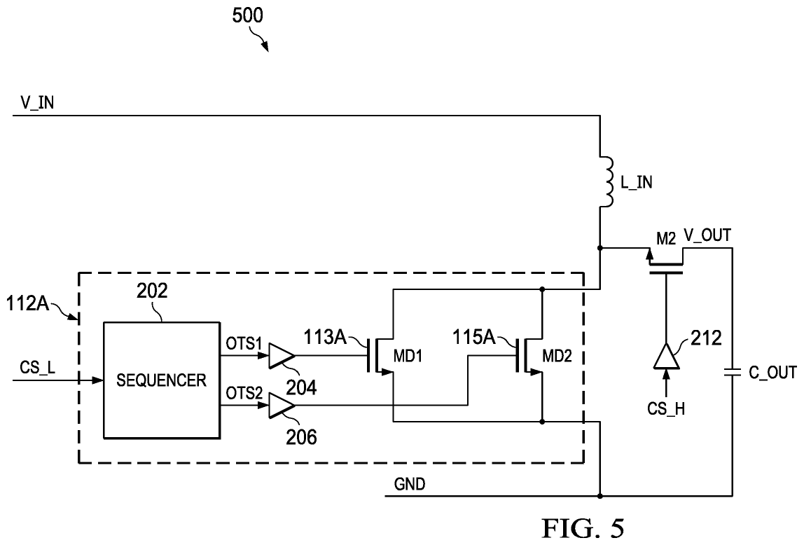

FIG. 5 shows a schematic diagram of a step-up power converter 500 in accordance with various examples. As shown, the step-up power converter 500 includes the dual switch 112A discussed previously in FIG. 2, where the dual switch 112A for the step-up power converter 500 is used as a low-side switch directed by a low-side switch control signal (CS_L). The step-up power converter 500 also includes an input-side inductor (L_IN), a high-side switch (M2) directed by a high-side switch control signal (CS_H) via a buffer 212, and an output-side capacitor (C_OUT). The converter topology represented in FIG. 5 is referred to as a “boost” converter. In other examples, the dual switch 112A is part of another step-up converter topology.

In the example of FIG. 5, each of the transistors MD1, MD2, and M2 has a gate, a first current terminal, and a second current terminal. As previously discussed, the gates for MD1, MD2, and M2 are coupled to respective buffers 204, 206, 212 and directed by high-side and low-side switch control signals (e.g., from a controller such as controller 102 in FIG. 1). More specifically, low-side switch control signal, CS_L, is used to generate the offset transition signals (OTS1 and OTS2) to direct MD1 and MD2. Also, the second current terminals of MD1 and MD2 in FIG. 5 are coupled to GND. Meanwhile, the first current terminals of MD1 and MD2 are coupled to L_IN and the second current terminal of M2. In the example of FIG. 5, MD1, MD2, and M2 are represented as NMOS transistors. In other examples, PMOS and/or bipolar transistors are used instead of NMOS transistors.

In different examples, the blocking voltages for MD1 and MD2 in the step-up power converter 500 vary. In one example, where the step-up power converter 500 converts 5 volts to 12 volts, MD1 has a blocking voltage of 12 volts and MD2 has a blocking voltage of 18 volts. In this example, the blocking voltage for MD2 is 50% larger than the blocking voltage for MD1. In other examples, the blocking voltages for MD1 and MD2 are both larger (e.g., 24 for MD1 and 36 for MD2). In other examples, the proportion of the blocking voltages varies (e.g., the blocking voltage for MD2 is 25% larger, 50% larger, 75% larger, or 100% larger than the blocking voltage for MD1). Also, in different examples, the values for V_IN, V_OUT, L_IN, and C_OUT for the step-up power converter 500 vary.

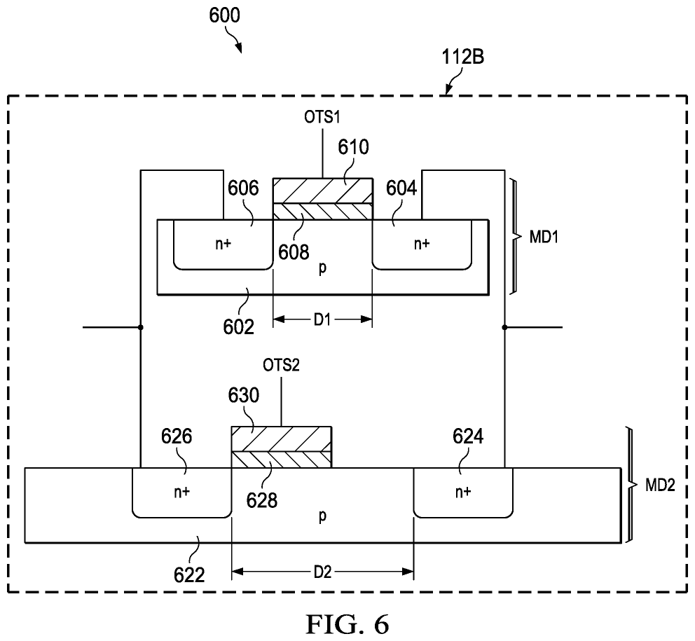

FIG. 6 shows a dual switch arrangement 600 with NMOS transistors in parallel in accordance with various examples. In arrangement 600, a dual switch 112B (an example of the dual switch 112 in FIG. 1 or the dual switch 112A in FIGS. 2, 4, and 5) with NMOS transistors for MD1 and MD2 is represented. As shown, MD1 has a p-type substrate 602 and two n-type regions 604 and 606, where region 606 corresponds to a source terminal for MD1 and region 604 corresponds to a drain terminal for MD1. Also, MD1 includes a gate terminal 610 separated from the p-type substrate 602 by an isolation layer 608 (e.g., an oxide layer). For MD1, the source-to-drain distance is given as D1. Meanwhile, MD2 has a p-type substrate 622 and two n-type regions 624 and 626, where region 626 corresponds to a source terminal for MD2 and region 624 corresponds to a drain terminal for MD2. Also, MD2 includes a gate terminal 630 separated from the p-type substrate 622 by an isolation layer 628 (e.g., an oxide layer). For MD2, the source-to-drain distance is given as D2. As represented in FIG. 6, the source-to-drain distance for MD2 is larger than the source-to-drain distance for MD1, resulting in a blocking voltage for MD2 that is greater than the blocking voltage for MD1. The reduced source-to-drain distance of MD1 (compared to MD2) results in a lower resistance, which reduces power loss in a step-up or step-down converter compared to using only a transistor with a larger source-to-drain distance (e.g., MD2).

In operation, offset transition signals (OTS1 and OTS2) result in respective signals being applied to the gate terminal 610 of MD1 and the gate terminal 630 of MD2. In response to the gate terminal 610 receiving a sufficient signal, a channel is formed in the p-type substrate 602, allowing electrons to flow from region 606 to region 604. Similarly, in response to the gate terminal 630 receiving a sufficient signal, a channel is formed in the p-type substrate 622, allowing electrons to flow from region 626 to region 624. As represented in FIG. 6, MD1 and MD2 are arranged in parallel by coupling the region 606 and 626 together, and by coupling the regions 604 and 624 together. In different examples, metal layers and/or external components are used couple regions 606 and 626 together, and to couple regions 604 and 624 together. In different examples, a dual switch 112B with arrangement 600 is used with a step-up transformer or a step-down transformer as described herein.

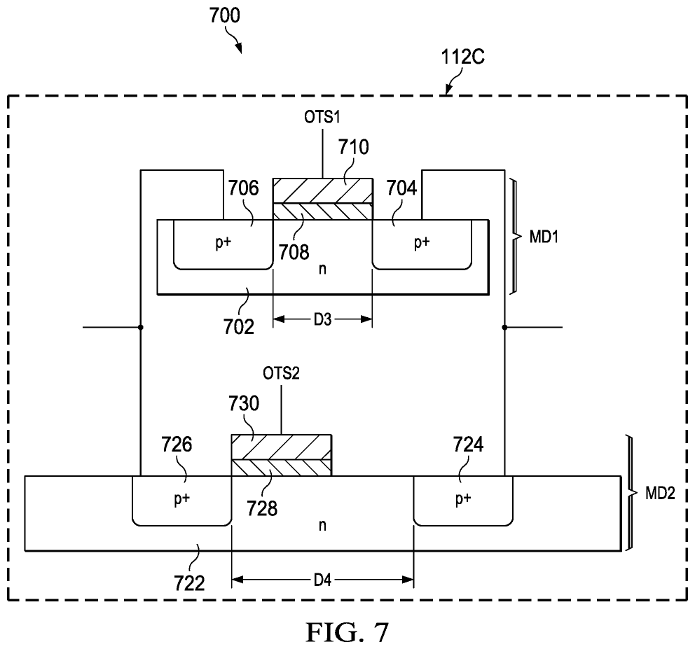

FIG. 7 shows a dual switch arrangement 700 with PMOS transistors in parallel in accordance with various examples. In arrangement 700, a dual switch 112C (an example of the dual switch 112 in FIG. 1 or the dual switch 112A in FIGS. 2, 4, and 5) with PMOS transistors for MD1 and MD2 is represented. As shown, MD1 has an n-type substrate 702 and two p-type regions 704 and 706, where region 706 corresponds to a source terminal for MD1 and region 704 corresponds to a drain terminal for MD1. Also, MD1 includes a gate terminal 710 separated from the n-type substrate 702 by an isolation layer 708 (e.g., an oxide layer). For MD1, the source-to-drain distance is given as D1. Meanwhile, MD2 has an n-type substrate 722 and two p-type regions 724 and 726, where region 726 corresponds to a source terminal for MD2 and region 724 corresponds to a drain terminal for MD2. Also, MD2 includes a gate terminal 730 separated from the n-type substrate 722 by an isolation layer 728 (e.g., an oxide layer). For MD2, the source-to-drain distance is given as D2. As represented in FIG. 7, the source-to-drain distance for MD2 is larger than the source-to-drain distance for MD1, resulting in a blocking voltage for MD2 that is greater than the blocking voltage for MD1.

In operation, offset transition signals (OTS1 and OTS2) result in respective signals being applied to the gate terminal 710 of MD1 and the gate terminal 730 of MD2. In response to the gate terminal 710 receiving a sufficient signal, a channel is formed in the n-type substrate 702, allowing holes to flow from region 704 to the region 706. Similarly, in response to the gate terminal 730 receiving a sufficient signal, a channel is formed in the n-type substrate 722, allowing holes to flow from region 724 to region 726. As represented in FIG. 7, MD1 and MD2 are arranged in parallel by coupling regions 706 and 726 together, and by coupling the regions 704 and 724 together. In different examples, metal layers and/or external components are used couple regions 706 and 726 together, and to couple regions 704 and 724 together. In different examples, a dual switch 112C with arrangement 700 is used with a step-up transformer or a step-down transformer as described herein.

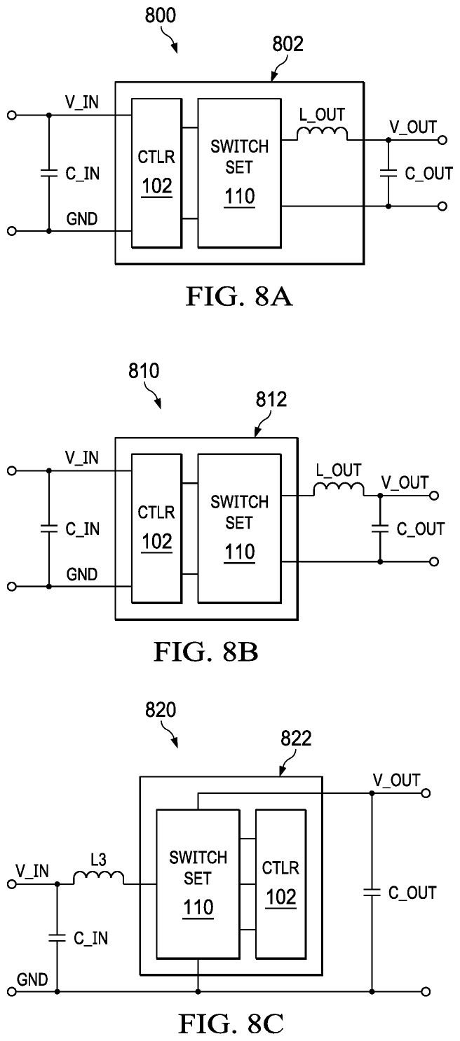

FIGS. 8A-8C show power converter device options in accordance with various examples. In option 800 of FIG. 8A, a power converter device 802 is represented. The power converter device 802 corresponds to a step-down converter in the form of one or more integrated circuits (e.g., a packaged or unpackaged chip), or components on a printed circuit board (PCB). As shown, the power converter device 802 includes the controller 102 and the switch set 110 described for FIG. 1. The power converter device 802 also includes an output-side inductor (L_OUT). The input-side capacitor (C_IN) and an output-side capacitor (C_OUT) are not included with the power converter device 802, and are selected by electrical system designers. For example, an electrical system designer selects a power converter device 802 having a particular step-down conversion (e.g., 12 volts to 5 volts, or 12 volts to 1 volt) as well as C_IN and C_OUT for a particular electrical system. In operation, the power converter device 802 converts an input voltage (V_IN) to a lower output voltage (V_OUT) using a dual switch with parallel transistors having different blocking voltages as a high-side switch as described herein. In some examples, the power converter device 802 includes feedback loop components (e.g., feedback loop components 106) as described herein to enable adjustments to power conversion operations over time based on voltage and/or current analysis.

In option 810 of FIG. 8B, another power converter device 812 is represented. The power converter device 812 corresponds to a step-down converter in the form of one or more integrated circuits (e.g., a packaged or unpackaged chip), or components on a printed circuit board (PCB). As shown, the power converter device 812 includes the controller 102 and the switch set 110 described for FIG. 1. The output-side inductor (L_OUT), the input-side capacitor (C_IN), and the output-side capacitor (C_OUT) are not included with the power converter device 812, and are selected by electrical system designers. For example, an electrical system designer selects a power converter device 812 having a particular step-down conversion (e.g., 12 volts to 5 volts, or 12 volts to 1 volt) as well as L_OUT, C_IN and C_OUT for a particular electrical system. In operation, the power converter device 812 converts an input voltage (V_IN) to a lower output voltage (V_OUT) using a dual switch with parallel transistors having different blocking voltages as a high-side switch as described herein. In some examples, the power converter device 812 includes feedback loop components (e.g., feedback loop components 106) as described herein to enable adjustments to power conversion operations over time based on voltage and/or current analysis.

In option 820 of FIG. 8C, another power converter device 822 is represented. The power converter device 822 corresponds to a step-up converter in the form of one or more integrated circuits (e.g., a packaged or unpackaged chip), or components on a printed circuit board (PCB). As shown, the power converter device 822 includes the controller 102 and the switch set 110 described for FIG. 1. An input-side inductor (L_IN) and an output-side capacitor (C_OUT) are not included with the power converter device 822, and are selected by electrical system designers. For example, an electrical system designer selects a power converter device 822 having a particular step-up conversion (e.g., 5 volts to 12 volts, or 1 volt to 12 volts) as well as L_IN and C_OUT for a particular electrical system. In operation, the power converter device 822 converts an input voltage (V_IN) to a higher output voltage (V_OUT) using a dual switch with parallel transistors having different blocking voltages as a low-side switch as described herein. In some examples, the power converter device 822 includes feedback loop components (e.g., feedback loop components 106) as described herein to enable adjustments to power conversion operations over time based on voltage and/or current analysis. Also, while the power converter devices 802, 812, and 822 in FIGS. 8A-8C are represented as including the controller 102, it should be appreciates that other power converter devices omit the controller 102 (e.g., the controller 102 is provided separate from the switch set and/or other components).

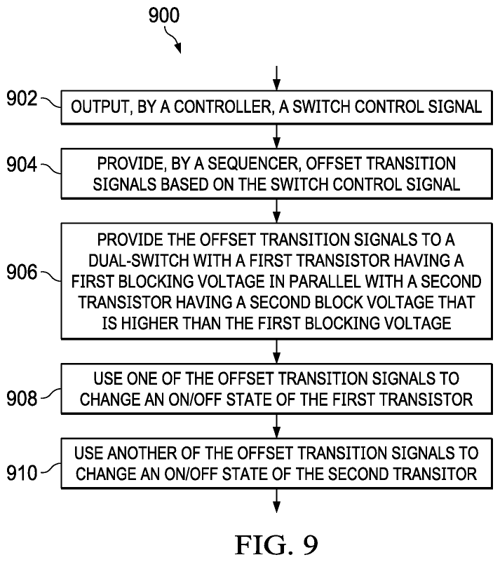

FIG. 9 shows a flowchart of a power conversion method 900 in accordance with various examples. In some examples, the method 900 relates to a high-side switch of a step-down converter. In other examples, the method 900 relates to a low-side switch of a step-up converter. As shown, the method 900 comprises outputting, by a controller (e.g., the controller 102 in FIG. 1), a switch control signal (e.g., CS_H or CS_L) at block 902. At block 904, a sequencer (e.g., sequencer 202 in FIGS. 2, 4, and 5) provides offset transition signals (e.g., OTS1 and OTS2) based on the switch control signal. At block 906, the offset transition signals are provided to parallel transistors (e.g., MD1 and MD2) including a first parallel transistor (e.g., MD1) having a first blocking voltage and a second parallel transistor (e.g., MD2) having a second blocking voltage that is higher than the first blocking voltage. At block 908, one of the offset transition signals is used to change an on/off state of the first parallel transistor (e.g., MD1). At block 910, another of the offset transition signals is used to change an on-off state of the second parallel transistor (e.g., MD2). As described herein, the timing of the operation of parallel transistors of a dual switch mostly overlaps with some offset between when the parallel transistors are turned on and off. This offset is controlled by the offset transition signals (e.g., OTS1 and OTS2) and has the function of easing on-to-off transitions and/or off-to-on transitions of the first parallel transistor (e.g., MD1) by having second parallel transistor (e.g., MD2) in an “on” state during transitions of the first transistor (e.g., MD1).

In some examples, providing offset transition signals at block 904 comprises, in response to an off-to-on switch control signal (e.g., CS_H or CS_L), generating a first off-to-on transition signal (e.g., OTS2) for the second parallel transistor (e.g., MD2) and a second off-to-on transition signal (e.g., OTS1) for the first parallel transistor (e.g., MD1), wherein the second off-to-on transition signal (e.g., OTS1) is delayed relative to the first off-to-on transition signal (e.g., OTS2). In some examples, providing offset transition signals at block 904 comprises, in response to an on-to-off switch control signal (e.g., CS_H or CS_L), generating a first on-to-off transition signal (e.g., OTS1) for the first parallel transistor (e.g., MD1) and a second on-to-off transition signal (e.g., OTS2) for the second parallel transistor (e.g., MD2), wherein the second on-to-off transition signal (e.g., OTS2) is delayed relative to the first on-to-off transition signal (e.g., OTS1).

In some examples, the method 900 comprises selecting a delay value between offset transition signals for the first and second parallel transistors. In some examples, the method 900 comprises adjusting a delay value between offset transition signals for the first and second parallel transistors. In at least some examples, the offset delay for an off-to-on transition is selected such that the first parallel transistor (e.g., MD1) turns on only after second parallel transistor (e.g., MD2) has fully turned on. Similarly, the offset delay for an on-to-off transition is selected such that second transistor (e.g., MD2) turns off only after first transistor (e.g., MD1) has fully turned off.

In some examples, the method 900 comprises selecting source-to-drain distances for the first transistor and second parallel transistors based on the first and second blocking voltages, and fabricating an integrated circuit with the first and second parallel transistors based on the selected source-to-drain distances, wherein at least one of the first and second parallel transistors is a PMOS transistor. In some examples, the method 900 comprises selecting source-to-drain distances for the first transistor and second parallel transistors based on the first and second blocking voltages, and fabricating an integrated circuit with the first and second parallel transistors based on the selected source-to-drain distances, wherein at least one of the first and second parallel transistors is an NMOS transistor. In some examples, the method 900 comprises receiving a feedback signal and adjusting a subsequent switch control signal based on the feedback signal. In such case, the method 900 also comprises providing, by the sequencer, offset transition signals to the first and second parallel transistors based on the subsequent switch control signal.

In this description, the term “couple” or “couples” means either an indirect or direct wired or wireless connection. Thus, if a first device couples to a second device, that connection may be through a direct connection or through an indirect connection via other devices and connections. Also, in this description, the recitation “based on” means “based at least in part on.” Therefore, if X is based on Y, then X may be a function of Y and any number of other factors.

Modifications are possible in the described embodiments, and other embodiments are possible, within the scope of the claims.

1. A power converter, comprising:
a first switch including a first transistor having a first blocking voltage in parallel with a second transistor having a second blocking voltage that is higher than the first blocking voltage, wherein the first transistor has a first source-to-drain distance that is smaller than a second source-to-drain distance of the second transistor;
a second switch;
a controller coupled to the first switch and the second switch and configured to provide switch control signals; and
a sequencer coupled to the first and second transistors and configured to generate offset transition signals for the first and second transistors based on [[a]] the switch control signals provided by the controller.

2. The power converter of claim 1, wherein, in response to an off-to-on switch control signal from the controller, the sequencer is configured to generate a first off-to-on transition signal for the second transistor and a second off-to-on transition signal for the first transistor, wherein the second off-to-on transition signal is delayed relative to the first off-to-on transition signal.

3. The power converter of claim 1, wherein, in response to an on-to-off switch control signal from the controller, the sequencer is configured to generate a first on-to-off transition signal for the first transistor and a second on-to-off transition signal for the second transistor, wherein the second on-to-off transition signal is delayed relative to the first on-to-off transition signal.

4. The power converter of claim 1, wherein a delay between offset transition signals for the first and second transistors has a predetermined length.

5. The power converter of claim 1, wherein a delay between offset transition signals for the first and second transistors is adjustable.

6. The power converter of claim 1, wherein at least one of the first and second transistors is an NMOS transistor.

7. The power converter of claim 1, wherein at least one of the first and second transistors is a PMOS transistor.

8. The power converter of claim 1, further comprising feedback loop components coupled to or included with the controller, wherein the feedback loop components are configured to provide a feedback signal to the controller based on at least one of a voltage analysis or a current analysis of an output voltage signal, and wherein the controller is configured to adjust switch control signals for the first switch and the second switch based on the feedback signal.

9. The power converter of claim 1, wherein the first blocking voltage is at least 25% smaller than the second blocking voltage.

10. The power converter of claim 1, wherein the power converter is a step-up converter, and wherein the first switch is arranged to perform low-side switching operations.

11. The power converter of claim 1, wherein the power converter is a step-down converter, and wherein the first switch is arranged to perform high-side switching operations.

12. A power conversion method, comprising:
outputting, by a controller, a switch control signal;
providing, by a sequencer, offset transition signals based on the switch control signal;
providing the offset transition signals to parallel transistors including a first parallel transistor having a first blocking voltage and a second parallel transistor having a second blocking voltage that is higher than the first blocking voltage, wherein the first transistor has a first source-to-drain distance that is smaller than a second source-to-drain distance of the second transistor;
using one of the offset transition signals to change an on/off state of the first parallel transistor; and
using another of the offset transition signals to change an on/off state of the second parallel transistor.

13. The method of claim 12, wherein the providing offset transition signals comprises, in response to an off-to-on switch control signal, generating a first off-to-on transition signal for the second parallel transistor and a second off-to-on transition signal for the first parallel transistor, wherein the second off-to-on transition signal is delayed relative to the first off-to-on transition signal.

14. The method of claim 12, wherein the providing offset transition signals comprises, in response to an on-to-off switch control signal, generating a first on-to-off transition signal for the first parallel transistor and a second on-to-off transition signal for the second parallel transistor, wherein the second on-to-off transition signal is delayed relative to the first on-to-off transition signal.

15. The method of claim 12, further comprising selecting a delay value between the offset transition signals for the first and second parallel transistors.

16. The method of claim 12, further comprising adjusting a delay value between the offset transition signals for the first and second parallel transistors.

17. The method of claim 12, further comprising selecting source-to-drain distances for the first parallel transistor and second parallel transistors based on the first and second blocking voltages, and fabricating an integrated circuit with the first and second parallel transistors based on the selected source-to-drain distances, wherein at least one of the first and second parallel transistors is a PMOS transistor.

18. The method of claim 12, further comprising selecting source-to-drain distances for the first transistor and second parallel transistors based on the first and second blocking voltages, and fabricating an integrated circuit with the first and second parallel transistors based on the selected source-to-drain distances, wherein at least one of the first and second parallel transistors is an NMOS transistor.

19. The method of claim 12, further comprising:
receiving a feedback signal and adjusting a subsequent switch control signal based on the feedback signal; and
providing, by the sequencer, offset transition signals to the first and second parallel transistors based on the subsequent switch control signal.

20. The method of claim 12, further comprising performing low-side switching operations of a step-up converter using the first and second parallel transistors.

21. The method of claim 12, further comprising performing high-side switching operations of a step-down converter using the first and second parallel transistors.
